(19) United States
(12) Patent Application Publication
(10) Pub. No.: US 2007/0033618 A1
(43) Pub. Date: Feb. 8, 2007

(54) Method of controlling linearity in communications system, terminal device, and receiver

(75) Inventors: Niko Kiukkonen, Veikkola (FI); Antti Piipponen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/434,923

(22) Filed: May 17, 2006

(30) Foreign Application Priority Data
Aug. 4, 2005 (FI) 20055424

(51) Int. Cl. H04N 7/173; H04N 7/16

(52) U.S. Cl. 725/62; 725/129; 725/117

(57) ABSTRACT

There is provided a terminal device, comprising a control unit for controlling functions of the terminal device and more than one communication units connected to the control unit for transmitting communication signals with one or more transmitters of the communication units and/or for receiving communication signals with one or more receivers of the communication units. The control unit is configured to detect transmission power levels of the one or more transmitters; and to adjust linearity of the one or more receivers on the basis of the detected transmission power levels of the transmitters.

### FIELD

The invention relates to a method of controlling linearity in a communications system, to a terminal device, to a receiver for a terminal device, to a computer program product, and to a computer program distribution medium.

### BACKGROUND

Radio terminals including multiple wireless systems have become more common. For example, GPS (Global Positioning System) receivers have been incorporated in mobile phones to enable position determination during emergency calls. Further, Bluetooth transceivers can be included in mobile phones for enabling the use of wireless headsets.

However, transmissions of a cellular transmitter can seriously harm operation (mostly reception) of other wireless systems in the same mobile phone. Likewise, transmitters of other systems can degrade the performance of a cellular receiver. Unless RF (Radio Frequency) front-ends (mainly low-noise amplifiers and mixers) of the systems are very linear, highly powerful interfering signals of the transmitters can desensitise them, or form intermodulation products with other interferers on the receive band. If the different wireless systems are operating at the same time, high linearity is required. The front-end linearity is a function of bias current; highly linear amplifiers require high bias, which in turn consumes power. For example, when a cellular transmitter is not active very high linearity of a GPS receiver front-end is not necessary and a lower bias current is sufficient.

Current solutions for helping to cope with the interference have included: a) not using different wireless systems at the same time, b) measuring the level of interference at the RF front-end and informing the backend that the front-end is overloaded, and c) using heavy pre-filtering and highly linear front-ends that withstand the interference of other systems. Thus, the controlling of the linearity has been reactive. The reactive control causes problems, for example, in GPS reception where the phase information of the incoming satellite signals should be undisturbed. If the linearity is increased after the interference is detected, the phase lock is easily lost.

### BRIEF DESCRIPTION OF THE INVENTION

An object of the invention is to provide an improved terminal device, a receiver, a computer program product, a computer program distribution medium, and an improved method of controlling linearity in a communications system.

According to an aspect of the invention, there is provided a method of controlling linearity in a communications system comprising at least one terminal device, the method comprising transmitting and/or receiving communication signals with more than one communication units of the terminal device. The method comprises: detecting transmission power levels of one or more transmitters of the communication units; and adjusting linearity of one or more receivers of the communication units on the basis of the detected transmission power levels of the transmitters.

According to another aspect of the invention, there is provided a terminal device, comprising a control unit for controlling functions of the terminal device and more than one communication units connected to the control unit for transmitting communication signals with one or more transmitters of the communication units and/or for receiving communication signals with one or more receivers of the communication units. The control unit is configured to detect transmission power levels of the one or more transmitters; and to adjust linearity of the one or more receivers on the basis of the detected transmission power levels of the transmitters.

According to another aspect of the invention, there is provided a receiver of a communication unit of a terminal device using more than one communication units having one or more transmitters for transmitting and/or one or more receivers for receiving communication signals, the receiver comprising: a control unit for controlling functions of the receiver. The control unit is configured to adjust linearity of the receiver of the communication unit on the basis of detected transmission power levels of one or more transmitters of the terminal device.

According to another aspect of the invention, there is provided a terminal device, comprising a control unit for controlling functions of the terminal device and more than one communication units for transmitting communication signals with one or more transmitters of the communication units and/or for receiving communication signals with one or more receivers of the communication units. The terminal device further comprises detecting means for detecting transmission power levels of the more than one transmitters; and

adjusting means for adjusting linearity of the one or more receivers of the terminal device on the basis of the detected transmission power levels of the transmitters.

According to another aspect of the invention, there is provided a receiver of a communication unit of a terminal device using more than one communication units having one or more transmitters for transmitting and/or one or more receivers for receiving communication signals, the receiver comprising: controlling means for controlling functions of the receiver. The receiver further comprises: adjusting means for adjusting linearity of the receiver of the communication unit on the basis of detected transmission power levels of one or more transmitters of the terminal device.

According to another aspect of the invention, there is provided a computer program product encoding a computer program of instructions for executing a computer process for controlling linearity, the process comprising transmitting and/or receiving communication signals with more than one communication units of the terminal device. The process further comprises: detecting transmission power levels of one or more transmitters of the communication units; and adjusting linearity of one or more receivers of the communication units on the basis of the detected transmission power levels of the transmitters.

According to another aspect of the invention, there is provided a computer program distribution medium readable by a computer and encoding a computer program of instructions for executing a computer process for controlling linearity, the process comprising transmitting and/or receiving communication signals with more than one communication units of the terminal device. The process further comprises: detecting transmission power levels of one or more transmitters of the communication units; and adjusting linearity of one or more receivers of the communication units on the basis of the detected transmission power levels of the transmitters.

The invention provides several advantages. Total power consumption of the terminal device can be reduced. The performance of receivers can be controlled depending on the operating conditions. Battery lives and operating times are increased. Reliability of terminal device interoperability is increased. The controlling of the linearity becomes proactive.

### LIST OF DRAWINGS

In the following, the invention will be described in greater detail with reference to the embodiments and the accompanying drawings, in which

FIG. 1 shows an example of a radio system;

FIG. 2 illustrates a simplified example of a receiver of a terminal device;

FIG. 3 illustrates a simplified example of a communication unit of a terminal device; and

FIGS. 4 and 5 illustrate examples of a method of controlling linearity in a communications system.

### DESCRIPTION OF EMBODIMENTS

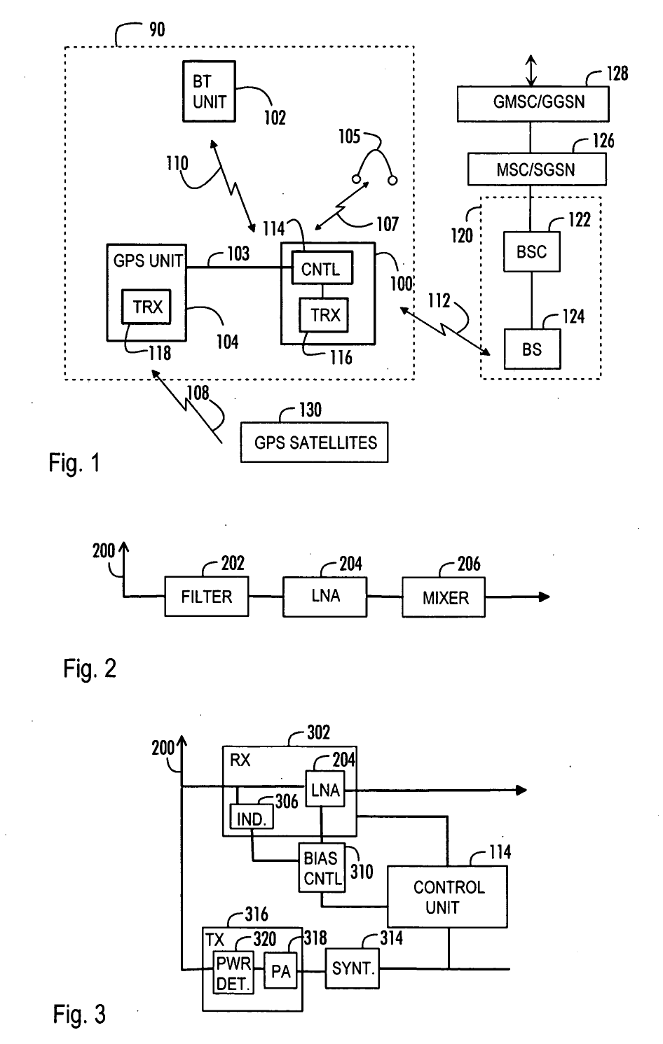

With reference to FIG. 1, let us examine an example of a structure of a radio system to which the preferred embodiments of the invention can be applied. The radio system can be based on, for example, the GSM (Global System for Mobile Communications), WCDMA (Wideband Code Division Multiple Access) or CDMA (Code Division Multiple Access). A terminal device 90 in FIG. 1 comprises a number of different communication system units 100, 102, 104, 105 in the same terminal device 90. The different communication systems included in the terminal device 90 may include a cellular unit 100 and a number of other communication units 102, 104, such as a GPS unit 104 or a Bluetooth unit 102, for example. The terminal device 90 may be a multiradio terminal, for example.

The communication units 100, 102, 104, 105 in the terminal device 90 may establish connections 112, 108 to different parts of a radio system, for example, to a radio network 120, and they may also receive transmissions from a GPS satellite system 130. The connections to other systems, such as the Internet, may be low power radio frequency (LPRF) connections and GSM/GPRS/EDGE connections 112 as well, for example. The communication units 100, 102, 104, 105 may also communicate with one another via different connections 103, 107, 110, such as Bluetooth or WLAN connections.

A cellular network may correspond to the combined structure of the GSM (Global System for Mobile Communications) and GPRS (General Packet Radio Service) systems, for example. The GSM network elements are responsible for the implementation of circuit-switched connections, and the GPRS network elements are responsible for the implementation of packet-switched connections, some of the network elements, however, being shared by both systems.

A centre 126 represents a mobile services switching centre (MSC) and a serving GPRS support node (SGSN) that enable circuit-switched and packet switched signalling, respectively, in the radio system. The cellular net-work may comprise a gateway unit 128, which is represented by a gateway mobile service switching centre (GMSC) and a gateway GPRS support node (GGSN). The GMSC attends to the circuit-switched connections between the cellular network and external networks, such as a public land mobile network (PLMN) or a public switched telephone network (PSTN), and the GGSN attends to the packet-switched connections between the cellular network and external networks such as the Internet.

The centre 126 controls a radio access network (RAN) 120, which may comprise at least one base station controller 122 controlling at least one base station 124. The base station controller 122 can also be called a radio network controller, and the base station 124 can be called node B. The cellular core unit 126 of the radio terminal equipment arrangement 90 communicates with at least one base station 124 over a radio interface.

The cellular unit 100 comprises at least a control unit 114 for controlling the functions of the terminal device 90. The control unit 114 is typically implemented with a microprocessor, a signal processor or separate components and associated software. The communication units 100, 102, 104, 105 also comprise transceiver units 116, 118 for transmitting and receiving communication signals. The cellular unit 100 may also comprise a SIM (Subscriber Identity Module) card including a memory.

The communication units 100, 102, 104, 105 in the terminal device 90 are optimized for specific tasks. One of the communication units is optimized for making basic phone calls and another communication unit is optimized for GPS functions, for example. The communication units may also comprise enhancement devices 105, such as headsets for listening to music or for routing calls thereto. The enhancement devices 105 may be connected to the other communication units with galvanic or wireless connections. The headset accessory may also include a camera, MP3 player and/or a radio.

In an embodiment, the control unit 114 of the terminal device 90 is configured to detect transmission power levels of one or more transmitters of the more than one communication units 102, 105, 116, 118 of the terminal device 90, and to adjust linearity of one or more receivers of the communication units 102, 105, 116, 118 on the basis of the detected transmission power levels of the transmitters. In an embodiment, the control unit 114 is configured to adjust the linearity of the one or more receivers by varying the bias current used in the receivers.

In an embodiment, the transmission power level of the transmitters of the communication units 102, 105, 116, 118 can be detected on the basis of transmission power control signals of the transmitters. In an embodiment, the bias current is varied as a function of the transmission power of the transmitters so that the communication units 102, 105, 116, 118 have variable linearities. For example, when there is only one transmitter operating at the same time a lower bias current may be used for saving power. Accordingly, when a transmitter of a given communication unit goes active then the other communication units may increase their bias currents for withstanding the interference caused by the active transmitter. Further, since maximum transmit power is rarely used, for example in cellular systems, the linearities can be scaled as a function of the transmit power.

The linearity of the one or more receivers may also be adjusted in other ways. US 20030124999, for example, describes different solutions of how linearity can also be adjusted. For example, in some radio systems it may be reasonable to grow linearity at the cost of random noise increasing, while power consumption stays constant. In some solutions the linearity, power consumption and random noise may behave such that while one of them is increased the other two deteriorate. Even such a case is sometimes possible that while power consumption is reduced, the linearity improves at the same time.

FIG. 2 illustrates a simplified example of a receiver part of a communication unit of a terminal device. The receiver may comprise an antenna 200, a filter 202 connected to the antenna 200, a low-noise amplifier 204 connected to the filter 202 and a mixer 206. The amplified signals are brought to the mixer 206 for mixing to intermediate frequencies. The receiver may also comprise further amplifiers, mixers, filters, demodulators, synthesizers, and oscillators known per se.

In an embodiment, the control unit 114 of the terminal device is further configured to vary bias currents of the low-noise amplifiers 204 or mixers 206 of the terminal device as functions of the detected transmission power levels of the transmitters used in the terminal device.

FIG. 3 illustrates a simplified example of a communication unit for a terminal device. The communication unit comprises: a control unit 114 for controlling functions of the communication unit, a receiver 302 and a transmitter 316 connected to the control unit 114. In addition to the low-noise amplifiers 204, the receiver 302 may further comprise indicator units 306, such as an overload indicator or an interference indicator. The communication unit further comprises a bias controller 310 that is controlled by the control unit 114, for example. On the basis of the control the bias controller 310 may generate bias current control signals to the low-noise amplifiers 204. The communication units may further comprise synthesizers 314, and the transmitter 316 may comprise power amplifiers 318 and power detectors 320.

In an embodiment, a power amplifier 318 of one or more communication units of the terminal device may be shut down when only one transmitter is active in the terminal device. In another embodiment, bias currents of one or more communication units of the terminal device are increased when a power amplifier 318 of some other communication unit of the terminal device is about to go active for withstanding interference. The control unit 114 may detect that the transmitter is about to go active on the basis of a transmitter 316 wake-up-signal provided for a synthesizer 314 in advance to allow the synthesizer to settle. In yet another embodiment, the bias currents of one or more receivers are decreased when a power amplifier 318 of some other communication unit's transmitter is turned off.

The control unit 114 may detect the transmission power level of the transmitters 316 on the basis of transmission power control signals. The transmission power control signals may be provided to the control unit 114 by the power detector 320, for example. In an embodiment, the control unit 114 may detect next to be used transmission power levels of the one or more transmitters 316. The control unit 114, for example, has beforehand knowledge about which transmission power levels to react in given radio systems. Thus, the linearity of the receivers can be adjusted even before the beginning of the transmission.

The overload or interference indicator 306 can be placed in the receiver 302 front-end for calibrating the required bias currents for different systems. The indicator 306 may also be used for detecting outside interference (e.g. intermodulation products). If outside the indicator 306 detects interference, then the bias current can be increased again.

Controlling the bias current of the low-noise amplifiers 204 is relatively simple and only a few steps are required. The bias current may be increased/decreased by the steps of ¼, ½, ¾, maximum bias current, for example.

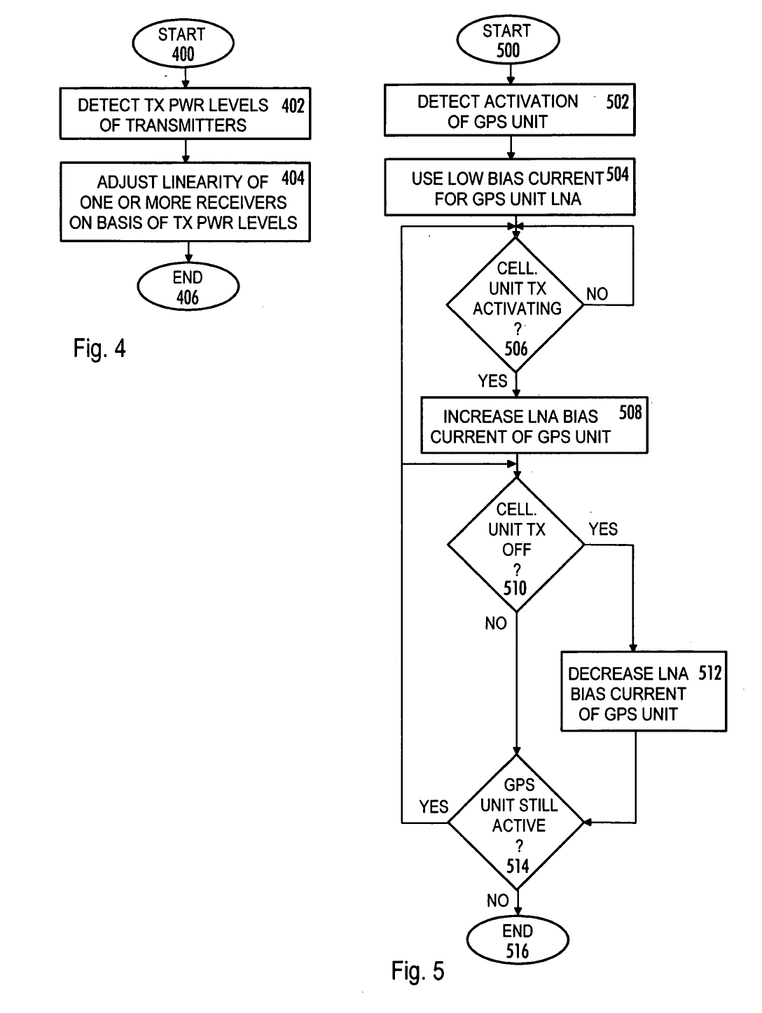

FIGS. 4 and 5 illustrate examples of a method of controlling linearity in a communications system. The method of FIG. 4 starts in 400. In 402, the transmission power levels of one or more transmitters of the terminal device are detected. In 404, the linearity of one or more receivers of the communication units is adjusted on the basis of the detected transmission power levels of the transmitters. The method ends in 406.

The method of FIG. 5 starts in 500. Let us assume that the terminal device in this example includes a cellular unit and a GPS unit. In the initial situation, both the cellular unit and the GPS unit are in an inactive state. In 502, it is detected that the GPS unit is about to receive communication signals. Based on that, in 504, a low bias current is used for the GPS unit low-noise amplifier. In 506, it is detected whether the cellular unit is about to go on. If the cellular unit is detected to be activated, then 508 is entered where the bias current of the GPS unit low-noise amplifier is increased for withstanding the interference caused by the cellular unit.

In 510, it is detected whether the cellular unit goes off, and that being the case, 512 is entered where the bias current of the GPS low-noise amplifier in decreased. In 514, it is detected whether the GPS unit is still active or not. If the GPS unit stays active, then 506 or 510 are re-entered where the state of the cellular unit is detected. This exemplary method ends in 516.

The main advantages of the embodiments of above described invention are that power is saved and reliability is improved because all the systems operating in the same terminal device can be taken into account easier. When only one transmitter or receiver is used, the lowest linearity can be used in the low-noise amplifiers. The embodiments of the invention enable the use of very low-power GPS receivers in mobile phones, for example. The GPS receiver can be operating even during phone calls when a high-linearity mode is used. The low-noise amplifier is one of the most power-consuming blocks in the receivers if it is designed to tolerate the high interference levels of other wireless systems in the same device. It is possible to achieve quite easily 50% power savings at the low-noise amplifiers by controlling the linearity on the basis of transmission power levels of other systems of the same terminal device. In an embodiment, it is not necessary to use power detectors at the receiver inputs. In that way some amount of current can also be saved.

The embodiments of the invention may be realized in electronic devices comprising a controller configured to perform at least some of the steps described in connection with the flowcharts of FIGS. 4 and 5. The embodiments may be implemented as a computer program comprising instructions for executing a computer process for controlling linearity, the process comprising transmitting and/or receiving communication signals with more than one communication units of the terminal device. The computer process further comprises: detecting transmission power levels of one or more transmitters of the communication units, and adjusting linearity of one or more receivers of the communication units on the basis of the detected transmission power levels of the transmitters.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a computer readable software distribution package, a computer readable signal, a computer readable telecommunications signal, or a computer readable compressed software package.

Even though the invention is described above with reference to an example according to the accompanying drawings, it is clear that the invention is not restricted thereto but it can be modified in several ways within the scope of the appended claims.

1. A method of controlling linearity in a communications system comprising at least one terminal device, the method comprising:
transmitting and/or receiving communication signals with communication units of the at least one terminal device;
detecting transmission power levels of at least one transmitter of the communication units; and
adjusting linearity of at least one receiver of the communication units on a basis of the detected transmission power levels of the at least one transmitter.

2. The method of claim 1, the method further comprising adjusting the linearity of the at least one receiver by varying a bias current used in the at least one receiver.

3. The method of claim 2, the method further comprising varying bias currents of one of low-noise amplifiers and mixers of the at least one terminal device as functions of the detected transmission power levels of the at least one transmitter used in the at least one terminal device.

4. The method of claim 2, the method further comprising using low bias currents for saving power when only one transmitter is active in the at least one terminal device.

5. The method of claim 2, the method further comprising increasing bias currents of the at least one receiver of the at least one terminal device when a power amplifier of another communication unit of the at least one terminal device is about to go active for withstanding interference.

6. The method of claim 5, the method further comprising detecting that the another communication unit is about to go active on a basis of a transmitter wake-up signal.

7. The method of claim 2, the method further comprising decreasing the bias currents of the at least one receiver of the at least one terminal device when a power amplifier of one or more communication units of the at least one terminal device is turned off.

8. The method of claim 2, the method further comprising detecting outside interference by the at least one terminal device, and varying the bias currents of the at least one receiver of the at least one terminal device when outside interference is detected.

9. The method of claim 1, w herein the step of detecting transmission power levels of the at least one transmitter comprises detecting a next to be used transmission power level of the at least one transmitter.

10. The method of claim 1, the method further comprising detecting transmission power levels of the at least one transmitter on a basis of transmission power control signals of the at least one transmitter.

11. The method of claim 1, the method further comprising shutting down power amplifiers of one or more communication units of the at least one terminal device when only one transmitter is active in the at least one terminal device.

12. A terminal device, comprising:
a control unit for controlling functions of the terminal device; and
communication units connected to the control unit for transmitting communication signals with at least one transmitter of the communication units and/or for receiving communication signals with at least one receiver of the communication units,
wherein the control unit is configured to detect transmission power levels of the at least one transmitter and to adjust linearity of the at least one receiver on a basis of the detected transmission power levels of the at least one transmitter.

13. The terminal device of claim 12, wherein the control unit is further configured to adjust the linearity of the at least one receiver by varying a bias current used in the at least one receiver.

14. The terminal device of claim 13, wherein the terminal device further comprises low-noise power amplifiers and mixers, and the control unit is further configured to vary bias currents of the low-noise power amplifiers or mixers of the terminal device as functions of the detected transmission power levels of the at least one transmitter used in the terminal device.

15. The terminal device of claim 14, wherein the control unit is further configured to shut down the low-noise power amplifiers of the terminal device when only one transmitter is active in the communication units.

16. The terminal device of claim 14, wherein the control unit is further configured to increase bias currents of the at least one receiver of the terminal device when a power amplifier of one or more communication units of the terminal device is about to go active for withstanding interference.

17. The terminal device of claim 14, wherein the control unit is further configured to decrease bias currents of the at least one receiver of the terminal device when a power amplifier of one or more communication units of the terminal device is turned off.

18. The terminal device of claim 13, wherein the control unit is further configured to use low bias currents for saving power when only one transmitter is active in the terminal device.

19. The terminal device of claim 13, wherein the control unit is further configured to detect outside interference by the terminal device, and to vary bias currents of one or more communication units of the terminal device when outside interference is detected.

20. The terminal device of claim 12, wherein the control unit is configured to detect a next to be used transmission power level of the at least one transmitter.

21. The terminal device of claim 12, wherein the control unit is further configured to detect the transmission power level of the at least one transmitter on a basis of transmission power control signals of the at least one transmitter.

22. A receiver of a communication unit of a terminal device using communication units comprising at least one transmitter for transmitting and/or at least one receiver for receiving communication signals, the receiver comprising:
a control unit for controlling functions of the at least one receiver, wherein the control unit is configured to adjust linearity of the at least one receiver of the communication unit on a basis of detected transmission power levels of the at least one transmitter of the terminal device.

23. The receiver of claim 22, wherein the control unit is configured to adjust the linearity of the at least one receiver by varying a bias current used in the at least one receiver.

24. The receiver of claim 23, wherein the at least one receiver further comprises a low-noise amplifier and a mixer, and the control unit is further configured to vary the bias current of the low-noise amplifier or the mixer as functions of the detected transmission power levels of the at least one transmitter of the terminal device.

25. The receiver of claim 24, wherein the control unit is further configured to shut down the low-noise amplifier of the receiver when only one transmitter is active in the terminal device.

26. The receiver of claim 24, wherein the control unit is further configured to increase the bias current of the low-noise amplifier when a transmitter of the terminal device is about to go active.

27. The receiver of claim 24, wherein the control unit is further configured to decrease the bias current of the low-noise amplifier when a low-noise amplifier of a transmitter of the terminal device is turned off.

28. The receiver of claim 23, wherein the control unit is further configured to use low bias currents for saving power when only one transmitter is active in the terminal device.

29. The receiver of claim 23, wherein the control unit is further configured to vary the bias current of the at least one receiver when outside interference is detected.

30. A terminal device, comprising:
a control unit for controlling functions of the terminal device;
communication units for transmitting communication signals with at least one transmitter of the communication units and/or for receiving communication signals with at least one receiver of the communication units;
detecting means for detecting transmission power levels of the at least one transmitter; and
adjusting means for adjusting linearity of the at least one receiver of the terminal device on a basis of the detected transmission power levels of the at least one transmitter.

31. The terminal device of claim 30, wherein the terminal device further comprises adjusting means for adjusting the linearity of the at least one receiver by varying a bias current used in the at least one receiver.

32. A receiver of a communication unit of a terminal device using more than one communication units comprising at least one transmitter for transmitting and/or at least one receiver for receiving communication signals, the receiver comprising:
controlling means for controlling functions of the receiver, the receiver further comprising adjusting means for adjusting linearity of the at least one receiver of the communication units on a basis of detected transmission power levels of the at least one transmitter of the terminal device.

33. The receiver of claim 32, wherein the receiver further comprises adjusting means for adjusting a linearity of the receiver by varying a bias current used in the receiver.

34. A computer program product encoding a computer program of instructions for executing a computer process for controlling linearity, the process comprising:
transmitting and/or receiving communication signals with communication units of a terminal device;
detecting transmission power levels of at least one transmitter of the communication units; and
adjusting linearity of at least one receiver of the communication units on a basis of the detected transmission power levels of the at least one transmitter.

35. The computer program product of claim 34, the process further comprising adjusting the linearity of the at least one receiver by varying bias current used in the at least one receiver.

36. A computer program distribution medium readable by a computer and encoding a computer program of instructions for executing a computer process for controlling linearity, the process comprising:
transmitting and/or receiving communication signals with communication units of a terminal device;
detecting transmission power levels of at least one transmitter of the communication units; and
adjusting linearity of at least one receiver of the communication units on a basis of the detected transmission power levels of the at least one transmitter.

37. The computer program distribution medium of claim 36, the process further comprising adjusting the linearity of the at least one receiver by varying a bias current used in the at least one receiver.

38. The computer program distribution medium of claim 36, the distribution medium including at least one of the following mediums: a computer readable medium, a program storage medium, a record medium, a computer readable memory, a computer readable software distribution package, a computer readable signal, a computer readable telecommunications signal, and a computer readable compressed software package.
